(19) United States
(12) Patent Application Publication
(10) Pub. No.: US 2005/0194574 A1
(43) Pub. Date: Sep. 8, 2005

(54) Aluminum elements and processes for the preparation of the same and chemical agents therefor

(76) Inventors: Masaaki Yamamuro, Chigasaki-shi (JP); Takaaki Sato, Chigasaki-shi (JP); Atsushi Kaneko, Chigasaki-shi (JP)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/065,073

(22) Filed: Feb. 24, 2005

(30) Foreign Application Priority Data
Mar. 2, 2004 (JP) 2004-57335
Sep. 10, 2004 (JP) 2004-263837

(51) Int. Cl. B32B 15/10; H01B 1/00

(52) U.S. Cl. 252/500; 428/651; 428/621; 427/402; 106/287.18; 106/287.27; 106/287.29; 106/285; 106/287.1; 106/287.3; 106/1.25; 106/1.27; 106/1.22

(57) ABSTRACT

There are provided aluminum elements covered on their surfaces with a coating film free from harmful hexavalent chromium compounds and fluorine compounds. Particularly, aluminum dicast and aluminum cast materials having excellent paint adherence and corrosion resistance are provided. The coating film for aluminum elements comprises (i) chromium, (ii) zinc and (iii) cobalt and/or titanium with 95% by mass or more of said chromium being a trivalent chromium.

### FIELD OF THE INVENTION

The present invention relates to an aluminum element or aluminum alloy element (herein after called aluminum element unless otherwise stated) having its surface covered with a coating film containing, as its primary component, a trivalent chromium etc., particularly aluminum die-casting and aluminum cast materials, and also a process for the preparation of the same and a chemical agent therefor.

### BACKGROUND OF THE INVENTION

It is known that aluminum elements and aluminum alloy elements are covered on their surfaces with various coating films such as anodized coating films, etc. to form a protective film thereon. So far as we know, however, there are no aluminum elements having their surfaces covered with a coating film according to the present invention. The present invention intends to provide an aluminum element having its surface covered with a new protective film. In addition to anodized coating films, various formation coating films, etc. are hitherto proposed as a protective film for aluminum elements. For example, they include various chromate treatments using a hexavalent chromium and phosphate treatments which are disclosed in Japanese Patent Application Publication No. 56-33468, Japanese Patent Application Public Disclosure No. 4-6281, etc. However, these treatments have burdensome problems such that the treating solutions contain a hexavalent chromium and fluorine or a complexed fluoride ion, etc., which are harmful substances and do not provide a sufficient corrosion resistance. Recently, as a countermeasure to the hexachromium problem, it is known that Japanese Patent Application Public Disclosure No. 52-131937, Japanese Patent Application Public Disclosure No.11-36082, Japanese Patent Application Public Disclosure No. 2000-199077, etc. have proposed a treating process using no hexavalent chromium. However, these treating processes have drawbacks such as the use of fluorine compounds, poor stability of the treating solution, troublesome waste water disposal, non-practicality, etc. In addition, these processes did not provide satisfactory protective coating performances for aluminum elements, which are their original objects. In other words, so far as we know, with respect to a protective coating film for aluminum elements, there is no formation coating film having satisfactory performances which is free from hexavalent chromium and fluoride compound. Thus, there are also no aluminum elements having their surfaces covered with such a coating film.

Patent Document 1:

Japanese Patent Application Publication No. 56-33468

Patent Document 2:

Japanese Patent Application Public Disclosure No. 4-6281

Patent Document 3:

Japanese Patent Application Public Disclosure No. 52-131937

Patent Document 4:

Japanese Patent Application Public Disclosure No.11-36082

Patent Document 5:

Patent Application Public Disclosure No. 2000-199077

### DISCLOSURE OF THE INVENTION

### Problem to be Solved by the Invention

It is an object of the present invention to provide aluminum elements having their surfaces covered with a coating film free from harmful hexavalent chromium and fluorine compound, particularly, aluminum die-casting and aluminum cast materials having excellent paint adherence and corrosion resistance.

The inventors have conducted extensive studies to overcome the prior art drawbacks. As a result, the inventors propose aluminum elements, at least a part of the surface of which is covered with a coating film containing (i) chromium, (ii) at least one selected from a group consisting of aluminum, titanium, vanadium, manganese, iron, cobalt, nickel, zinc, zirconium, molybdenum and wolfram, and (iii) at least one ions selected from the group consisting of sulfate ions, nitrate ions, chlorine ions, and oxyacid ions of chlorine or boron, oxyacid ions of phosphorus, with at least 95% by mass of said chromium being a trivalent chromium.

More particularly, the present invention provides aluminum elements, at least a part of the surface of which is covered with a coating film containing (i) chromium, (ii) zinc and (iii) at least one selected from the group consisting of aluminum, titanium, vanadium, cobalt and nickel, with at least 95% by mass of said chromium being a trivalent chromium, and more particularly, provides aluminum elements, at least a part of the surface of which is covered with a coating film containing (i) aluminum, (ii) zinc and (iii) cobalt and/or titanium with at least 95% by mass of said chromium being a trivalent chromium. It has been found that these coatings impart an excellent paint adherence and a corrosion resistance to aluminum members.

For the role of various components in a coating film according to the present invention, (1) chromium is a component which is necessary to give the coating film a basic corrosion resistance. For example, it is believed that it provides a barrier action against corrosion causes. This can be easily presumed from the fact that when the chromium is merely replaced with other metal such as, for example, zirconium or manganese which is conventionally used in the prior art, the corrosion resistance greatly decreases. In order to develop the chromium's effect, it is desirable that the coating film contains 1% by weight or more, preferably 5% by weight or more, and more preferably 7% by weight or more of chromium. (2) zinc provides nuclei (or base points) for the formation of a coating film on the aluminum element. By this function, even if the treating solution does not contain a fluorine compound which constitutes one of the burdensome problems in the prior art, it permits a coating film to form. However, excess zinc leads to decreased corrosion resistance. It is desirable, therefore, that the amount of zinc present in the coating film is 1% to 95%, preferably 3% to 90% and more preferably .5% to 85% by weight. It is believed that (3) cobalt and titanium impart a trivalent chromium corrosion resistance (for example, the suppression of decrease in corrosion resistance when the coating film breaks down) to the coating film. However, excess cobalt and titanium result in adverse effects such as decreased corrosion resistance, etc. It is desirable, therefore, that the amount of them present in the coating film is from 0.005% to 20%, preferably from 0.02% to 10% by weight.

The coating film may further contain anionic ions such as sulfate ions, nitrate ions, chloride ions, ions of oxyacids of chlorine or boron and ions of oxyacids of phosphorus, a compound such as a chelating agent, a silicon compound, compounds of alkali metals, alkaline earth metals, vanadium, manganese, nickel, tin, gold, silver, copper, aluminum, iron and zirconium, whereby higher corrosion resistance is obtained. Further, improved appearance is also provided by anionic ions such as sulfate ions, nitrate ions, complex fluoride ions, chloride ions, ions of oxyacids of chlorine or boron and ions of oxyacids of phosphorus, a sulfur compound, fluorine (including fluorine compounds containing fluoride ions, complex fluoride ions, etc.), etc.

The thickness of these coating films is about 20 nm or more, preferably 40 nm or more, and more preferably 70 nm or more. Further, more corrosion resistance improvement can be also expected by covering at least a portion of the coating film surface with a coating layer of an overcoat agent.

Among the processes for obtaining the aluminum elements of the present invention are included,
(A) a process for the preparation of aluminum elements which comprises contacting, one or more times, an aluminum element with an aqueous nucleating (primary) solution containing one or more alkali hydroxides and zinc, and thereafter, one or more times, further with an aqueous trivalent chromium (secondary) solution having a pH of from 0.5 to 6, said trivalent chromium solution comprising (i) chromium and (ii) cobalt and/or titanium, with 95% or more of said chromium being a trivalent chromium,
(B) a process for the preparation of aluminum elements which comprises contacting, one or more times, an aluminum element with an aqueous nucleating (primary) solution containing one or more alkali hydroxides and zinc, and thereafter, one or more times, further with an aqueous trivalent chromium (secondary) solution having a pH of from 0.5 to 6, comprising (i) chromium and (ii) cobalt and/or titanium with 95% or more of said chromium being a trivalent chromium, wherein the aluminum element is contacted, in between contacts with the aqueous nucleating solution, with an intermediate treating solution containing one or more ions selected from the group consisting of sulfate ions, nitrate ions, ions of oxyacids of chlorine, phosphorus or boron, and ions of organic acids, and
(C) In these processes, prior to contacting with an aqueous nucleating (primary) solution containing one or more alkali hydroxides and zinc, the aluminum element is contacted, one or more times, with a pretreatment containing a fluorine compound and/or oxyacid of phosphorus, which may further include a step of bringing, one or more times, the aluminum element obtained by any one of these processes into contact with an overcoat agent.

With this pretreatment, the surfaces of the elements or members are cleaned and activated, so that the adhesion and appearance in subsequent treatment are improved. Moreover, the nucleating liquid provides nuclei for reaction in subsequent treatment to the surface.

More particularly, according to the present invention, it is preferred that the pretreatment solution contains 0.1 to 600 g/L preferably 1 to 300 g/L of a fluorine compound and/or 10 to 850 g/L preferably 50 to 700 g/L of an oxyacid of phosphorus. This pretreatment solution may further contain 0.05 to 20 g/L preferably 0.1 to 15 g/L of sulfate ions and/or 10 to 400 g/L preferably 30 to 350 g/L of nitrate ions. Feed sources for these components are not particularly restricted. The fluorine compounds include hydrofluoric acid, ammonium fluoride, acidic ammonium fluoride, borofluoric acid and the like. The oxyacids of phosphorus include phosphoric acid, phosphorous acid, hypophosphorous acid and salts of them. As surfactant, anions, cations, nonions and amphoteric ions may be cited. The sulfate ions or nitrate ions can be their own acids or salts of any of these ions with an alkali metal or other metal.

The process of treating an aluminum element with a pretreatment solution can be any spraying, etc., but immersion is preferred with the immersion with rocking or agitating, etc. being most preferred. For the treating conditions, it is desirable to treat it with a pretreatment solution at room temperature (for example, 5 to 35° C.) for a period of from one second to 3 minutes preferably 10 seconds to 2 minutes.

It is desirable that the primary treating solution contains 3 to 600 g/L preferably 50 to 500 g/L of an alkali hydroxide and 0.5 to 200 g/L preferably 1 to 50 g/L of zinc. If these amounts are less than their lower limits, desired results are not obtained. On the other hand, if they are more than their upper limits, unfavorable problems occur such as excessive treatment, economical loss, etc. This primary treating solution can further contain 0.01 to 20 g/L preferably 0.05 to 5 g/L of one or more metals selected from the group consisting of iron, nickel, cobalt and copper and/or 0.5 to 150 g/L preferably 1 to 100 g/L more preferably 5 to 60 g/L of one or more substances selected from the group consisting of organic acids, salts thereof and amine compounds. Feed sources for these components are not particularly restricted. For example, the alkali hydroxides are supplied from hydroxides of various alkali metals and hydroxides of alkaline earth metals. Zinc, iron, nickel, cobalt and copper are supplied from zinc oxide, and chlorides, sulfates, nitrates, hydroxides, carbonates, etc. Useful organic acids and salts thereof include various carboxylic acids and sulfonic acids, more specifically, formic acid, acetic acid, propyonic acid, gluconic acid, butyric acid, oxalic acid, malonic acid, succinic acid, glutaric acid, adipic acid, maleic acid, fumaric acid, benzoic acid, phthalic acid, tartaric acid, glycolic acid, diglycolic acid, lactic acid, glycine, citric acid, malic acid, ethylenediaminetetraacetic acid, nitrilotriacetic acid, methanesulfonic acid, ethanesulfonic acid, toluenesulfonic acid, benzenesulfonic acid, etc. and salts thereof. Suitable amine compounds include aliphatic or aromatic amines having at least one amino group, alkali metal salts and ammonium salts thereof, (poly)alkylene polyamines, alkanolamines, etc. More specifically, they include primary, trivalent chromium and tertiary amines such as methylamine, ethylamine, propylamine, isopropylamine, butylamine, isobutylamine, pentylamine, isopentylamine, hexylamine, dimethylamine, diethylamine, dipropylamine, diisopropylamine, N-methyl ethylamine, N-ethyl isopropylamine, N,N-dimethyl propylamine, trimethylamine, etc., ammonium salts such as tetramethyl ammonium chloride, tetramethyl ammonium hydroxide, tetraethyl ammonium chloride, tetraethyl ammonium, hydroxide, etc., (poly)alkylene polyamines such as ethylene diamine, propylene diamine, trimethylene diamine, tetramethylene diamine, pentamethylene diamine, hexamethylene diamine, diethylene triamine, triethylene tetramine, tetraethylene pentamine, etc., alkanolamines such as monoethanolamine, diethanolamine, triethanolamine, 2-amino-1-butanol, 3-propanediol, ethyl monoethanolamine, dimethyl ethanolamine, diethyl ethanolamine, dibutyl ethanolamine, butyl diethanolamine, etc., aromatic amines such as choline, aniline, toluidine, methylaniline, diphenylamine, phenylene diamine, etc. They can be used singly or in a combination of two or more.

The process of contacting an aluminum element with a primary treating solution can be any spraying, but immersion with rocking, agitating, etc. is particularly preferred. For the treating conditions, it is desirable to treat it with a primary treating solution at a temperature of from 0 to 70° C. preferably 10 to 65° C. for a period of one second to 3 minutes preferably 10 seconds to 2 minutes. When it is immersed two or more times in a primary treating solution, it is also possible to alter the concentrations of the treating solutions and the treating conditions used in their respective treating processes. When the two or more immersions are used, it is generally preferable that the latter immersions use a higher concentration, a higher temperature and a longer period of time.

The intermediate treatment in between the primary treatments is carried out with the use of an intermediate treating solution containing 1 to 400 g/L preferably 20 to 200 g/L of one or more ions selected from the group consisting of sulfate ions, nitrate ions, ions of oxyacids of chlorine, phosphorus or boron, and ions of organic acids. At less than this concentration, desired results are not obtained. On the other hand, at more than this concentration, the functional effects hit the ceiling, which leads to increased cost. When the intermediate treating solution is complicated in its composition, it has drawbacks that the functional effects are not very high and the process control becomes more complex. By selecting one or two types of ions, therefore, it is basically preferred to effect the treating with an intermediate treating solution having as simple composition as possible. For feed sources for these components, the above feed sources can be used.

The process of contacting an aluminum element with an intermediate treating solution can be any spraying, etc., but immersion is preferred and immersion with rocking, agitating, etc. is particularly preferred. For the treating conditions, it is desirable to treat it with an intermediate solution at room temperature (for example, 5 to 35° C.) for a period of from one second to 2 minutes preferably 10 seconds to one minute. It is also possible to conduct the treatment under other conditions (both of temperature and time) than these conditions. However, there can be found no prominent merits in using the other conditions in consideration of influences on energy cost and production capability, etc.

By these treatments, the present invention intends to deposit zinc on the surface of an aluminum element, which becomes nuclei in the formation of a coating film by a secondary treating solution. In conjecturing from the treating conditions, etc., it is believed that zinc is deposited in a very small amount, and forms a coating film of the order of 2 μm at the maximum and about 1 μm or less on the average and probably a very thin coating film of from 0.1 to 0.01 μm or less as calculated in terms of film thickness. Further, it is believed that the zinc deposited in a secondary treatment dissolves and reacts while being. incorporated in a coating film by the secondary treatment. Thus, it is uncertain whether the trace of a primary treatment is observed on an aluminum element having been subjected to the secondary treatment.

It is desirable that the secondary treating solution is an aqueous solution having a pH of from 0.5 to 6 and containing 0.01 to 45 g/L preferably 0.1 to 10 g/L more preferably 1 to 5 g/L of a trivalent chromium and 0.005 to 20 g/L preferably 0.01 to 10 g/L more preferably 0.1 to 5 g/L of cobalt and/or titanium. This treating solution can further contain 0.1 to 150 g/L preferably 1 to 100 g/L more preferably 2 to 50 g/L of one or more ions selected from the group consisting of sulfate ions, nitrate ions, chloride ions and ions of oxyacids of chlorine or boron, 0.1 to 80 g/L preferably 0.5 to 50 g/L more preferably 1 to 30 g/L of a chelating agent, 0.01 to 200 g/L preferably 0.1 to 50 g/L more preferably 0.5 to 4 g/L of a silicon compound, 0.01 to 350 g/L preferably 0.1 to 250 g/L more preferably 0.5 to 150 g/L of a sulfur compound, 0.01 to 100 g/L preferably 0.05 to 80 g/L more preferably 0.1 to 50 g/L of ions of an oxyacid of phosphorus, 0.01 to 150 g/L of one or more metal ions selected from the group consisting of compounds of alkali metals, alkaline earth metals, vanadium, manganese, nickel, tin, gold, silver, copper, aluminum, iron and zirconium, whereby further improvements of corrosion resistance and appearance are obtained. For the metal ions, when the metal is an alkali metal or an alkaline earth metal, the amount of from 1 to 150 g/L preferably 3 to 100 g/L and more preferably 5 to 80 g/L is suitable. For the other metals, the amount of from 0.01 to 50 g/L preferably 0.1 to 30 g/L and more preferably 0.5 to 5 g/L is suitable. If these components are present in an amount less than the above lower limits, desired results are not obtained. On the other hand, more than the above upper limits, unfavorable problems occur such as inconveniences due to excessive treatment, an increase in cost, etc.

According to the present invention, the secondary treating solution can use, as the feed source for trivalent chromium, various compounds containing a trivalent chromium. More specifically, it is possible to use salts such as chromium nitrate, chromium sulfate, chromium chloride, chromium phosphate, chromium acetate, etc. and also compounds obtained by reducing hexavalent chromium compounds such as chromic acid, bichromate salts, etc. to a trivalent state by a reducing agent. For feed sources for anions such as nitrate ions, sulfate ions, chloride ions, ions of oxyacids of phosphorus, borate ions, etc., their own acids and salts thereof can be used. It is also possible to supply them as a metal salt with other component such as a trivalent chromium, etc. or also as their own acids or metal salts thereof. Of these anions, the most important anions are nitrate ions which are useful for the stability of corrosion resistance, etc. Illustrative of the sulfur compounds are many compounds such as sodium sulfide, potassium sulfide, ammonium sulfide, calcium sulfide, sodium thiosulfate, sodium hydrosulfide, etc., with organic sulfur compounds being particularly preferable. Specifically, they include thioureas such as thiourea, allythiourea, ethylene thiourea, diethyl thiourea, diphenyl thiourea, tolyl thiourea, guanyl thiourea, acetyl thiourea, etc., mercaptans such as mercaptoethanol, mercaptohypoxatine, mercaptobenzimidazole, mercaptobenzthiazole, etc., thiocyanic acids and salts thereof, amino compounds such as aminothiazole, etc., as well as the trade names “NOCCELER TMV”, “NOCCELER TBT”, “NOCCELER-NS-P”, “NOCRAC TBTV”, “NOCRAC NS- 10N” of Ouchishinko Chemical Industrial Co., Ltd., and “Accel 22-R”, “Accel 22-S”, “Accel CZ”, “Accel EUR-H”, “Accel LVR”, “Accel TET”, “Accel TP”, etc. of Kawaguchi Chemical Industrial Co., Ltd. Further, thibcarboxylic acids and salts thereof such as thioformic acid, thioacetic acid, thiomalic acid, thioglycolic acid, thiodiglycolic acid, thiocarbamic acid, thiosalicylic acid, etc., as well as dithiocarboxylic acids and salts thereof such as dithioformic acid, dithioacetic acid, dithioglycolic acid, dithiodiglycolic acid, dithiocarbamic acid, etc. are also useful as these compounds have a skeleton similar to that of a chelating agent. As the chelating agent, the above amino compounds, monocarboxylic acids, dicarboxylic acids, tricarboxylic acids, hydroxycarboxylic acids, ammonia, aminocarboxylic acids and salts thereof can be used. Of them, carboxylic acids particularly succinic acid, malic acid, malonic acid, oxalic acid, acrylic acid, formic acid, acetic acid, tartaric acid, citric acid, glutamic acid, ascorbic acid, inosinic acid, lactic acid, glycolic acid, diglycolic acid and salts thereof are useful for the uniformity of appearance, the formation of thick coating films, etc. As the silicon compound, it is preferable-to use sodium silicate, potassium silicate, lithium silicate, or colloidal silicas having a particle diameter of 200 nm or less and preferably 100 nm or less. It is possible to use one substance selected from the group consisting anions, metal ions and chelating agents. When two or more substances are used, however, it is also possible to supply them at the same time by the use of salts thereof. Other basic matters are as in the above pretreatments and primary treating solutions.

The process of contacting an aluminum element with a secondary treating solution may be any spraying, but immersion is preferred with the immersion with rocking, agitating, etc. being particularly preferred. For the treating conditions, the treating temperature is from 5 to 60° C. preferably 20 to 50° C. and more preferably 25 to 45° C. The treating time is from one second to 3 minutes preferably 10 seconds to 2 minutes and more preferably 20 seconds to 90 seconds. The pH of the treating solution is from 0.5 to 6.5 preferably 1.5 to 5.5 and more preferably 1.8 to 5.

For the surface active agents, various commercial surfactant products can be used in an appropriate amount. It is possible to effect fine control of the frictional characteristics of coating films by the type and concentration of surface active agent used. Further, it is also possible to subject these coating films to a commercial overcoat agent. As the surface active agents, all kinds of surfactants can be used. Particularly, cationic surfactants are preferable, and more particularly aliphatic amine salts, quaternary ammonium salts, EO addition types of quaternary ammonium salts are preferable. Specifically, they include the following trade names: “FARMIN”, “QUARTAMIN” and “SANISOL” (manufactured by Kao Corporation), “DOUMEEN”, “ARMAC”, “AUQUAD” and “ETHOQUAD” (manufactured by Lion Akzo Corporation), “Cation” (manufactured by NOF Corporation), “ACECA MINE” (manufactured by Asahi Denka Co., Ltd.), etc. It is desirable that the concentration of surface active agents in the treating solution is from 0.01 to 50 g/L preferably 0.1 to 30 g/L. The overcoat agents are not particularly restricted and contain, as the primary component, a resin(s) such as acrylic resins, olefin resins, alkyd resins, urea resins, epoxy resins, melamine resins, fluorine resins, polyethylenes, polyvinyl chlorides, polystyrenes, polypropylenes, methacrylic resins, phenol resins, polyester resins, polyurethanes, polyamides, polycarbonates, etc., silicates, colloidal silicas and the like. The concentration of these resins in the overcoat agent is from 0.01 to 800 g/L. It is difficult topredicate an appropriate concentration as it varies with the purpose of treatment, the type of resins, etc. Illustrative of overcoat agents are the following trade names: “Cosmercoat” (manufactured by Kansai Paint Co., Ltd.), “Triner TR-170” (manufactured by Nippon Hyoumen Kagaku K.K.), “Finiguard” (manufactured by Conventa), etc. Illustrative of acrylic resins are “HITALEX” (manufactured by Hitachi Chemical Co., Ltd.), “Acryset” (manufactured by Nippon Shokubai Co., Ltd.), etc. Illustrative of olefin resins are “FRO-THENE” (manufactured by Sumitomo Seika Chemicals Co., Ltd.), “PES” (manufactured by Nippon Unicar Company Limited), “CHEMIPEARE” (manufactured by Mitsui Chemicals, Inc.), “Sunfine” (Asahi Kasei Corporation), etc.

The process of contacting an aluminum element with an overcoat agent and a surface active agent can be any spraying, etc., but immersion is preferred with the immersion with rocking, agitating, etc. being particularly preferred. For the treating conditions, in case of surface active agents and silicon compounds, the treating temperature is from 5 to 60° C. preferably 10 to 50° C. and more particularly 15 to 45° C. In case of resins, although the stability of the resins varies with the type thereof, the treating temperature is generally from 5 to 35° C. and preferably 15 to 25° C. The treating time is from one second to 3 minutes preferably 10 seconds to 2 minutes and more preferably 20 seconds to 90 seconds. The pH of the treating solution is from 0.5 to 6.5 preferably 1.5 to 6 and more preferably 1.8 to 5.5.

The aimed aluminum elements of the present invention can be obtained by treating an aluminum element with the above chemical agents according to the above processes and thereafter drying it under appropriate conditions (for example, 40 to 100° C., one minute to 15 minutes). Further, it is desirable that the aluminum element is washed with water between the steps.

The present invention has also found that an aluminum element having at least a portion of its surface covered with a coating film comprising (i) chromium, and (ii) at least two selected from the group consisting of sulfuric acid compound, nitric acid compound, chlorine compound, oxyacid compound containing chlorine or boron, oxyacid compound of phosphorus and fluorine compound and with 95% by mass of said chromium being a trivalent chromium, imparts superior adhesion of the coating film, superior anti-corrosion property and a practical appearance to the aluminum element. This coating film is not necessarily required to contain zinc unlike the above-mentioned coating film. Particularly superior results are obtained when one or two of the at least two selected from the group consisting of a sulfuric acid compound, a nitric acid compound, a chlorine compound, an oxyacid compound containing chlorine or boron and an oxyacid compound of phosphorus and a fluorine compound is fluorine compound and/or oxyacid compound of phosphorus.

Further, the properties can be further enhanced if this coating film contains at least two selected from the group consisting of a chelating agent, a silicon compound, a sulfur compound, a dye, compounds of alkali metals, alkaline earth metals, aluminum, titanium, vanadium, cobalt, nickel, manganese, tin, gold, silver, copper, iron and zirconium. Particularly, when at least one of them is selected from the compounds of alkali metals, alkaline earth metals, aluminum, titanium, vanadium, cobalt, nickel, manganese, tin, gold, silver, copper, iron, zirconium stable properties are obtained.

In order to produce an element or member covered with this coating film, the process used for forming this coating film is different from that for the previously described element, which was treated with an alkaline solution (primary treatment) and an acidic solution (secondary treatment). In this embodiment, the element may be treated with a detergent, an activator and a trivalent chromium solution only within neutral and acidic conditions. Further, this treatment does not require primary treatment step with alkaline solution which step is not usually provided in the existing commercial processing lines and thus the introduction of this treatment does not increase the number of steps. This treatment can omit the primary treatment by using a trivalent chromium solution containing 0.01-150 g/L, more preferably 0.1-100 g/L of a fluorine compound. As such fluorine compound, hydrofluoric acid, silicohydrofluoric acid, borohydrofluoric acid and/or their salts are preferred.

The sources of detergent, activator, surface active agent used for the composition, organic acid, its salt, amine compound, fluorine compound, anions, and metal compounds are the same or similar to those which were already described in the foregoing.

The detergent cleans the surface of the element and provides a superior bonding strength and an excellent outer appearance after the surface has been activated. Further, the activator serves to remove stains and reaction-deterring matters which were not entirely removed with the detergent, or to smoothen subsequent reactions. These treatment is typically carried out using the dipping method although other methods such as spray method are allowed.

The detergent contains 0.001-300 g/L, preferably 0.1-100 g/L of surface active agent, and additionally 0.001-250 g/L, preferably 0.01-150 g/L of at least one of organic acids, salts thereof, amine compounds, fluorine compounds, oxyacid compounds of phosphorus. The treatment temperature is preferably at room temperature to 90° C., preferably 40-70° C. and the treatment time is from 10 seconds to 30 minutes, preferably 1-10 minutes. Also, various pHs may be used but, to suppress the surface roughness to the minimum, 3.5-10.5, preferably 4.5-9.5, are preferred.

The activator contains 10-850 g/L, preferably 5-700 g/L of oxyacid of phosphorus and/or 0.1-600 g/L, preferably 0.5-400 g/L of fluorine compound, and additionally 0.01-100 g/L, preferably 0.1-55 g/L of at least one selected from surface active agents, organic acids, their salts and amines may be used. The treatment temperature is generally at room temperature to 70° C., preferably 15-70° C. and the treatment time is from 10 seconds to 30 minutes, preferably from 30 seconds to 10 minutes.

As the conditions for treating with detergent and activator, if the time is too short, the temperature is too low and the concentration is too low, their aimed effects are not obtained. If the time is too long, the temperature is too high and the concentration is too high, the treatment becomes too excessive and the economical loss becomes large.

The trivalent chromium solution contains 0.01-50 g/L, preferably 0.1-15 g/L, more preferably 0.5-5 g/L of trivalent chromium and 0.1-600 g/L, preferably 5-500 g/L, more preferably 1-400 g/L in total of at least two type of ions selected from the group consisting of sulfate ions, nitrate ions, chlorine ions, oxyacid ions of chlorine or boron, oxyacid ions of phosphorus, fluorine ions and ions of fluorine compound, with at least one type being fluorine ions, ions of fluorine compound and/or oxyacid ions of phosphorus. If fluorine ions and ions of fluorine compound are used, the amount is 0.01-250 g/L, preferably 0.5-150 g/L, more preferably 01.-250 g/L, and if oxyacid ions of phosphorus are used, the amount is 1-300 g/L, preferably 5-150 g/L.

When chelating agent, silicon compound, sulfur compound, dye, or compound or compounds of alkali metal, alkali earth metal, aluminum, titanium, vanadium, cobalt, nickel, manganese, tin, gold, silver, copper, iron, zirconium or zinc are contained in the trivalent chromium solution, the proper amount(s) is as already mentioned regarding the secondary treatment agent.

The method for contacting the trivalent chromium solution with aluminum element may be the spray method but the-immersion method is preferred, and the most preferred is immersion with shaking or agitation of the solution. The treatment conditions are at a temperature of 50-80° C., preferably 15-70° C., more preferably 20-65 ° C. for a period of 1 seconds-10 minutes, preferably 10 seconds-5 minutes, more preferably 20 seconds-90 seconds, at a pH of 0.5-6.5, preferably 1-5, more preferably 1.5-4.

### Effects of the Invention

The present invention provides aluminum element at least partially coated with a coating film which does not contain harmful hexavalent chromium, but particularly contains (i) chromium, (ii) zinc, and (iii) cobalt and/or titanium, with 90% or more by mass of the chromium being trivalent chromium, or a coating film which contains (i) chromium and (ii) at least two selected from the group consisting of sulfur compound, nitrate compound, chlorine compound, oxyacid compound of chlorine or boron, oxyacid compound of phosphorus and fluorine compound.

The present invention provides aluminum elements having practicality and appearance which could not be obtained in the prior art, and also excellent corrosion resistance which could not be obtained even if hexavalent chromium was used. Further, the present invention has an advantage that the desired object can be attained even without using environmental loading substances such as fluorine, phosphoric acid, which were almost essential in conventional techniques.

Further, the present invention has also great advantages in cost such as lower treatment temperature, shorter treating time, etc. Hitherto, the harmfulness of hexavalent chromium has long been known, but switchover therefrom has not considerably progressed. The present invention has solved many unfavorable problems of the prior art. Therefore, it is believed that the present invention is utilized in a wide variety of fields so that it will speed up the switchover from hexachromium.

### Examples

The present invention will be described with reference to Examples. Tests were performed after aluminum test pieces (ADC12, trade name, having a dimension of 50×100×0.5 mm) is subjected to a suitable pretreatment such as defatting, etc. and then to appropriate treatments. Corrosion resistance was evaluated by a salt spray test according to Japanese Industrial Standard JIS Z 2731. Paint adherence was evaluated by coating an epoxy-type paint on the surface of a test piece, baking the coated test piece, cross-cutting the backed test piece in a gridiron pattern, immersing the test piece in a boiling water for 30 minutes, pressing a cellophane tape on it and thereafter peeling it therefrom in a perpendicular direction.

### Working Examples 1-7

An aluminum element was obtained by immersing a test piece in a primary treating solution as shown in Table 1 at 40° C. for 50 seconds and then in a secondary treating solution of a pH 4.3 containing 15 g/L of chromium nitrate, 2 g/L of cobalt nitrate, 7 g/L of oxalic acid and 4 g/L of sodium nitrate at 30° C. for 55 seconds with gentle agitation, and thereafter drying the test piece thus treated at a temperature of from 60 to 80° C. for 5 minutes.

TABLE 1
Unit: g/l

| | Primary treating solution | | | | | | |
|---|---|---|---|---|---|---|---|
| Component | 1 | 2 | 3 | 4 | 5 | 6 | 7 |
| Sodium hydroxide | 50 | 80 | 480 | 250 | 118 | 200 | 50 |
| Potassium hydroxide | | 10 | | | 75 | | |
| Zinc oxide | 6.2 | 8 | 120 | 70 | 45 | 60 | 12 |
| Cobalt sulfate | | 0.8 | | 0.5 | | | |
| Nickel sulfate | | | | | 3 | 7 | |
| Potassium sodium | | | | | 20 | 60 | |
| tartrate | | | | | | | |
| Methanesulfonic acid | | | | 10 | | | |
| Triethanolamine | | | | | 50 | 30 | 5 |
| Triethylenetetramine | | | | | 10 | | |

### Working Examples 8 and 9

Aluminum elements were prepared as in Working Examples 1 and 2 with the exception that prior to the treatments of Working Examples 2 and 4, the test piece was immersed in an aqueous solution containing 12 g/L of acidic ammonium fluoride at 30° C. for 20 seconds.

### Working Example 10

An aluminum element was prepared as in Working Example 5 with the exception that prior to the treatment of Working Example 5, the test piece was immersed in the primary treating solution of Working Example 1 at 20° C. for 30 seconds.

### Working Example 11

An aluminum element was obtained by immersing a test piece in the primary treating solution of Working Example 3 and then in an aqueous solution containing 80 g/L of nitric acid at room temperature for 30 seconds, and thereafter treating it as in Working Example 6.

### Working Example 12

An aluminum element was obtained by immersing a test piece in the primary treating solution of Working Example 1 at 25° C. for 30 seconds and then in an aqueous solution containing 70 g/L of nitric acid at room temperature for 30 seconds and then in the primary treating solution of Working Example 7 at 35° C. for 60 seconds, and further in a secondary treating solution of a pH 4.5 containing 20 g/L of chromium nitrate, 6 g/L of sodium nitrate and 2 g/L of cobalt chloride at 30° C. for 55 seconds with gentle agitation, and thereafter drying the test piece thus treated at a temperature of from 60 to 80° C. for 5 minutes.

### Working Example 13

An aluminum element was obtained by immersing a test piece in the primary treating solution of Working Example 1 at 25° C. for 30 minutes, then in an aqueous solution containing 70 g/L of nitric acid at room temperature for 30 seconds, further in the primary treating solution of Working Example 7 at 35° C. for 60 seconds and furthermore in a secondary treating solution of a pH 4.4 containing 20 g/L of chromium nitrate, 6 g/L of sodium nitrate, 2 g/L of cobalt nitrate, 7 g/L of oxalic acid and 1 g/L of malonic acid at 30° C. for 55 seconds with gentle agitation, and thereafter drying the test piece thus treated at a temperature of from 60 to 80° C. for 5 minutes.

### Working Example 14

An aluminum element was prepared as in Working Example 13 with the exception that 3 g/L of sodium silicate was further incorporated in the secondary treating solution of Working Example 13.

### Working Example 15

An aluminum element was prepared as in Working Example 14 with the exception that 3 g/L of ammonium vanadate was further incorporated in the secondary treating solution of Working Example 14.

### Working Example 16

An aluminum element was prepared as in Working Example 15 with the exception that 1.5 g/L of thiourea was further incorporated in the secondary treating solution of Working Example 15.

### Working Example 17

An aluminum element was prepared as in Working Example 16 with the exception that 0.1 g/L of phosphoric acid was further incorporated in the secondary treating solution of Working Example 16.

### Working-Example 18

Example 13 was repeated to obtain an aluminum element that 1 g/L of zirconia sol was incorporated in the secondary treating solution of Working Example 13.

### Working Example 19

Example 13 was repeated to obtain an aluminum element except that 2 g/L of alumina sol was incorporated in the secondary treating solution of Working Example 13.

### Working Example 20

Example 13 was repeated to obtain an aluminum element except that cobalt nitrate in the secondary treating solution of Working Example 13 was reduced to 1.5 g/L and 0.4 g/L of titanium sulfate was incorporated in the secondary treating solution.

### Working Example 21

Example 13 was repeated to obtain an aluminum element except that cobalt nitrate in the secondary treating solution of Working Example 13 was reduced to 1.5 g/L and 1 g/L of sodium tungstate was incorporated in the secondary treating solution.

### Working Example 22

Example 13 was repeated to obtain an aluminum element except that cobalt nitrate in the secondary treating solution of Working Example 13 was reduced to 1.5 g/L and 0.8 g/L of manganese nitrate was incorporated in the secondary treating solution.

### Working Example 23

Example 13 was repeated to obtain an aluminum element except that cobalt nitrate in the secondary treating solution of Working Example 13 was reduced to 1.5 g/L and 0.5 g/L of nickel sulfate was incorporated in the secondary treating solution.

### Working Example 24.

A test piece was immersed in an aqueous solution containing 15 g/L of ammonium acid fluoride at 30° C. for 20 seconds and thereafter immersed in a solution containing 15 g/L of chromium nitrate, 2 g/L of cobalt nitrate, 7 g/L of oxalic acid, 4 g/L of sodium nitrate, 8 g/L of ammonium acid fluoride, having pH of 2.0 at 50° C. for 60 seconds with a gentle agitation, and thereafter dried at 60-80° C. for 5 minutes to obtain an aluminum element.

### Working Example 25

A test piece was immersed in an aqueous solution of pH 8 containing 1 g/L of Nonion HS (tradename, manufactured by Nihon Yushi K.K.) and 0.02 g/L of phosphoric acid at 65° C. for 5 minutes, and then immersed in a treating solution of pH 1.9 containing 10 g/L of chromium nitrate, 3 g/L of cobalt nitrate, 2 g/L of ammonium vanadate, 10 g/L of malonic acid, 0.2 g/L of sodium sulfate, 10 g/L of ammonium acid fluoride at 55° C. for 50 seconds with shaking the test piece. The test piece was then washed with water and dried at 60-80° C. for 5 minutes to obtain an aluminum element.

### Working Example 26

A test piece was immersed in an aqueous solution of pH 5.5 containing 10 g/L of Nonion HS (trade name, manufactured by Nihon Yushi K.K.) at 65° C. for 5 minutes, then in an aqueous solution containing 20 g/L of ammonium acid fluoride and 100 g/L of phosphoric acid at 30° C. for 30 minutes, and thereafter in a treating solution containing 15 g/L of chromium nitrate, 3 g/L of cobalt nitrate, 2 g/L of ammonium vanadate, 10 g/L of malonic acid, 0.2 g/L of sodium sulfate, 10 g/L of ammonium acid fluoride, having a pH of 1.9, at 55° C. for 50 seconds with shaking the test piece. The test piece was then washed with water and dried at 60-80° C. for 5 minutes to obtain an aluminum element.

### Working Example 27

A test piece was immersed in an aqueous solution containing 5 g/L of Nonion HS (trade name, manufactured by Nihon Yushi K.K.). and 15 g/L of ammonium acid fluoride at 40° C. for 30 seconds, and thereafter in a treating solution containing 15 g/L of chromium nitrate, 3 g/L of cobalt nitrate, 2 g/L of ammonium vanadate, 10 g/L of malonic acid, 0.2 g/L of sodium sulfate, 10 g/L of ammonium acid fluoride, 5 g/L of colloidal silica, having a pH of 1.9, at 55° C. for 50 seconds with shaking the test piece. The test piece was then washed with water and dried at 60-80° C. for 5 minutes to obtain an aluminum element.

### Working Example 28

Example 26 was repeated to obtain an aluminum element except that cobalt nitrate in the secondary treating solution of Working Example 26 was reduced to 2 g/L and 0.3 g/L of titanium sulfate was incorporated in the secondary treating solution.

### Working Example 29

Example 26 was repeated to obtain an aluminum element except that cobalt nitrate in the secondary treating solution of Working Example 26 was reduced to 1.5 g/L and 0.7 g/L of sodium tungstate was incorporated in the secondary treating solution.

### Working Example 30

Example 26 was repeated to obtain an aluminum element except that cobalt nitrate in the secondary treating solution of Working Example 26 was reduced to 2 g/L and 0.9 g/L of manganese nitrate was incorporated in the secondary treating solution.

### Working Example 31

Example 26 was repeated to obtain an aluminum element except that cobalt nitrate in the secondary treating solution of Working Example 26 was reduced to 1.5 g/L and 0.8 g/L of nickel sulfate was incorporated in the secondary treating solution.

### Working Example 32

Example 26 was repeated to obtain an aluminum element except that 0.7 g/L of zirconia sol was incorporated in the secondary treating solution.

### Working Example 33

Example 26 was repeated to obtain an aluminum element except that 1.8 g/L of alumna sol was incorporated in the secondary treating solution.

### Working Example 34

Example 13 was repeated to obtain an aluminum element except that 0.5 g/L of hypophosphorous acid and 1 g/L of iron nitrate were incorporated in the secondary treating solution. Black appearance was obtained.

### Working Example 35

Example 13 was repeated to obtain an aluminum element except that 0.6 g/L of hypophosphorous acid and 1 g/L of ammonium molybdate were incorporated in the secondary treating solution. Black appearance was obtained.

### Working Example 36

Example 13 was repeated to obtain an aluminum element except that 0.6 g/L of silver nitrate was incorporated in the secondary treating solution. Black appearance was obtained.

### Working Example 37

Example 13 was repeated to obtain an aluminum element except that 1 g/L of copper sulfate was incorporated in the secondary treating solution. Black appearance was obtained.

### Working Example 38

Example 26 was repeated to obtain an aluminum element except that 0.9 g/L of sodium hypophosphate and 1 g/L of iron nitrate were incorporated in the secondary treating solution. Black appearance was obtained.

### Working Example 39

Example 26 was repeated to obtain an aluminum element except that 1.3 g/L of sodium hypophosphate and 1.5 g/L of ammonium molybdate were incorporated in the secondary treating solution. Black appearance was obtained.

### Working Example 40

Example 26 was repeated to obtain an aluminum element except that 0.6 g/L of silver nitrate was incorporated in the secondary treating solution. Black appearance was obtained.

### Working Example 41

Example 26 was repeated to obtain an aluminum element except that 0.6 g/L of copper sulfate was incorporated in the secondary treating solution. Black appearance was obtained.

### Comparative Example 1

Corrosion resistance test and paint adherence test were conducted on a test piece having no treatment subjected thereto.

### Comparative Example 2

An aluminum element was obtained by immersing a test piece in an aqueous solution containing 12 g/L of chromic acid anhydride (containing about 6 g/L of hexavalent chromium), 35 ml/L of a 75% phosphoric acid and 3 g/L of acidic ammonium fluoride at 40° C. for 60 seconds.

### Comparative Example 3

An aluminum element was obtained by subjecting a test piece to a spraying treatment (25° C., 25 seconds) with an aqueous solution having been adjusted to a pH of 2.7 with nitric acid, said aqueous solution containing 0.24 g/L of ammonium fluorozirconate, 0.29 g/L of phosphoric acid, 0.05 g/L of hydrofluoric acid and 0.26 g/L of fluoroboric acid.

### Comparative Example 4

An aluminum element was obtained by immersing a test piece in an aqueous solution containing 50 g/L of sodium hydroxide and 6.2 g/L of zinc oxide at 20° C. for 30 seconds, and thereafter subjecting the test piece to an immersion treatment (45 °C., 70 seconds, pH 3) with a solution containing 2 g/L of magnesium hydrogen phosphate, 10 g/L of calcium dihydrogen phosphate, 0.2 g/L of barium nitrate, 0.2 g/L of strontium sulfate, 10 g/L of phosphoric acid, 5 g/L of pyrophosphoric acid, 3 g/L of phosphorous acid and 1 g/L of potassium titanate.

The test results are shown in Table 2 wherein ◯ is good, × is unacceptable, and ×× is worse.

TABLE 2

| | Corrosion resistance | | Paint adherance | |
|---|---|---|---|---|
| Working | ◯ | No rusting over | ◯ | No peeling observed |
| examples 1-33 | | 96 hours | | |
| Comparative | XX | Entire surface | XX | Entire peeling |
| example 1 | | rusting in one hour | | |
| Comparative | XX | Entire surface | X | 10% peeling |
| example 2 | | rusting in 24 hours | | |
| Comparative | XX | Entire surface | X | 20% peeling |
| example 3 | | rusting in 3 hours | | |
| Comparative | X | Rusting in less | ◯ | No peeling observed |
| example 4 | | than 48 hours | | |

1. An aluminum element having at least a portion of its surface covered with a coating film containing (i) chromium, (ii) at least one selected from the group consisting of aluminum, titanium, vanadium, manganese, iron, cobalt, nickel, zinc, zirconium, molybdenum, and wolfram, and (iii) at least one type of ions selected from the group consisting of sulfate ions, nitrate ions, chlorine ions, oxyacid ions of chlorine or boron, oxyacid ions of phosphorus, and fluorine ions, with 95% or more by mass of said chromium being a trivalent chromium.

2. The aluminum element according to claim 1, wherein the component (ii) is zinc and at least one selected from the group consisting of aluminum, titanium, vanadium, cobalt and nickel.

3. The aluminum element according to claim 1, wherein the coating film further contains at least one selected from compounds of alkali metal, alkaline earth metal, manganese, nickel, silver, copper, aluminum, vanadium, tin, iron and zirconium.

4. The aluminum element according to claim 1, wherein the coating film further contains at least two selected from the group consisting of sulfuric acid compound, nitric acid compound, chlorine compound, oxyacid compound containing chlorine or boron, oxyacid compound of phosphorus, and fluorine compound.

5. The aluminum element according to claim 1, wherein the coating film is free of zinc.

6. The aluminum element according to claim 4, wherein one or two of the at least two selected from the group consisting of sulfuric acid compound, nitric acid compound, chlorine compound, oxyacid compound containing chlorine or boron, oxyacid compound of phosphorus, and fluorine compound are at least one of oxyacid compound of phosphorus or fluorine compound.

7. The aluminum element according to claim 4 wherein the coating film contains at least two selected from the group consisting of compounds of alkali metals, alkaline earth metals, aluminum, titanium, vanadium, cobalt, nickel, manganese, tin, gold, silver, copper, iron, and zirconium.

8. The aluminum element according to claim 7 wherein at least one of the at least two selected from the group consisting of compounds of alkali metals, alkaline earth metals, aluminum, titanium, vanadium, cobalt, nickel, manganese, tin, gold, silver, copper, iron and zirconium is selected from aluminum, titanium, vanadium, cobalt, and nickel.

9. The aluminum element according to claim 1, wherein the coating film is coated with at least one selected from the group consisting of an overcoat agent, a surface active agent, a dye, and a silicon compound.

10. The aluminum element according to claim 1, wherein the coating film further contains a chelating compound.

11. The aluminum element according to claim 1, wherein the coating film further contains a silicon compound.

12. The aluminum element according to claim 1, wherein the coating film further contains a sulfur compound.

13. The aluminum element according to claim 1, wherein the coating film further contains an oxyacid compound of phosphorus.

14. The aluminum element according to claim 1, wherein the coating film further contains fluorine ions.

15. The aluminum element according to claim 1, wherein the coating film further contains a dye.

16. A process for the preparation of a coated aluminum element comprising contacting, one or more times, an aluminum element with an aqueous nucleating solution containing one or more alkali hydroxides and zinc, and thereafter contacting the aluminum element, one or more times, further with an aqueous trivalent chromium solution having a pH of from 0.5 to 6, containing (i) chromium and (ii) at least one selected from the group consisting of aluminum, titanium, vanadium, cobalt, and nickel, with 95% or more of said chromium being a trivalent chromium.

17. A process for the preparation of aluminum elements according to claim 16, comprising contacting the aluminum element before contacting with the nucleating solution or between contacts with the aqueous nucleating solution, with an intermediate treating solution containing one or more ions selected from the group consisting of sulfate ions, nitrate ions, ions of oxyacids of chlorine, phosphorus or boron, and ions of organic acids.

18. The process of claim 16, comprising prior to contacting with the aqueous nucleating solution containing one or more alkali hydroxides and zinc, contacting the aluminum elemen,t one or more times, with a pretreatment liquid containing at least one of a surface active agent, a fluorine compound and an oxyacid of phosphorus.

19. The process of claim 16, wherein the nucleating solution further contains at least one selected from the group consisting of iron, nickel, cobalt and copper.

20. The process of claim 16, wherein the nucleating solution further contains at least one selected from the group consisting of an organic acids, salts of the acids, and amine compounds.

21. The process of claim 16, wherein the aqueous trivalent chromium solution further contains at least one type of ions selected from the group consisting of sulfate ions, nitrate ions, chloride ions, and ions of oxyacids of chlorine or boron.

22. The process of claims 16, wherein the aqueous trivalent chromium solution further contains one or more compounds of metal selected from the group consisting of alkali metals, alkaline earth metals, vanadium, manganese, nickel, tin, gold, silver, copper, aluminum, iron, and zirconium.

23. The process of claims 16, wherein the aqueous trivalent chromium solution further contains oxyacid ions of phosphorus.

24. The process of claims 16 wherein the aqueous trivalent chromium solution further contains a fluorine compound.

25. A process for preparing a coated aluminum element, comprising immersing an aluminum element at least once in a cleaning solution containing a surface active agent as a detergent, and thereafter immersing the element at least once in a trivalent chromium solution having a pH of 0.5-6 and containing (i) chromium and (ii) at least one type of ions selected from the group consisting of sulfate ions, nitrate ions, chlorine ions, oxyacid ions of chlorine or boron, oxyacid ions of phosphorus and fluorine ions, with 95% or more by mass of said chromium being a trivalent chromium.

26. A process for preparing a coated aluminum element, comprising immersing an aluminum element at least once in an activating solution containing at least one of oxyacids of phosphorus, fluorine ions and ions of fluorine compounds, and thereafter immersing the element at least once in a trivalent chromium solution having a pH of 0.5-6 and containing (i) chromium and (ii) at least two types of ions selected from the group consisting of sulfate ions, nitrate ions, chlorine ions, oxyacid ions of chlorine or boron, oxyacid ions of phosphorus and fluorine ions, with 95% or more by mass of said chromium being a trivalent chromium.

27. The process according to claim 25, wherein the cleaning solution contains at least one selected from the group consisting of organic acids, salts of the acids, amine compounds, fluorine compounds, and oxyacids of phosphorus.

28. The process according to claim 26, wherein the activating solution contains at least one selected from the group consisting of organic acids, salts of the acids, amine compounds, and surface active agents.

29. The process according to claim 25, wherein the trivalent chromium solution contains at least two selected from the group consisting of sulfuric acid compounds, nitric acid compounds, chlorine compounds, and oxyacids of chlorine or boron, and at least one of the at least two are selected from the oxyacids of phosphorus and fluorine compounds.

30. The process according to claim 25, wherein the trivalent chromium solution contains at least two compounds of metals selected from the group consisting of alkali metals, alkaline earth metals, aluminum, titanium, vanadium, cobalt, nickel, manganese, tin, gold, silver, copper, iron, and zirconium.

31. The process according to claim 30, wherein at least one of the at least two compounds of metals selected from the group consisting of alkali metals, alkaline earth metals, aluminum, titanium, vanadium, cobalt, nickel, manganese, tin, gold, silver, copper, iron, and zirconium is selected from compounds of metals selected from the group consisting of aluminum, titanium, vanadium, cobalt and nickel.

32. The process according to claim 16, wherein the trivalent chromium solution contains at least one selected from the group of a silicon compound, a sulfur compound, and a dye.

33. The process according to claim 17, wherein the trivalent chromium solution contains at least one selected from the group of a silicon compound, a sulfur compound, and a dye.

34. The process according to claim 25, wherein the trivalent chromium solution contains at least one selected from the group of a silicon compound, a sulfur compound, and a dye.

35. The process according to claim 26, wherein the trivalent chromium solution contains at least one selected from the group of a silicon compound, a sulfur compound, and a dye.

36. The process according to claim 16, comprising, after treating with the trivalent chromium solution, contacting the surface of the aluminum element at least once with at least one selected from overcoat agents, surface active agents, coating materials, resins, dyes, and silicon compounds.

37. An aqueous nucleating solution for use in the process of claim 16, comprising 3 g/L to 600 g/L of an alkali hydroxide and 0.5 g/L to 200 g/L of zinc.

38. The aqueous nucleating solution of claim 37 further containing 0.01 g/L to 20 g/L of one or more metals selected from the group consisting of iron, nickel, cobalt, and copper.

39. The aqueous nucleating solution of claim 37 further containing 0.5 g/L to 150 g/L of one or more substances selected from the group consisting of organic acids, organic acid salts, and amine compounds.

40. An aqueous trivalent chromium solution for the process of claim 16, comprising 0.01 g/L to 45 g/L of a trivalent chromium and 0.005 g/L to 25 g/L of at least one selected from the group consisting of aluminum, titanium, vanadium, cobalt, and nickel, with the pH being from 0.5 to 6.

41. The aqueous trivalent chromium solution of claim 40, further containing 0.01 g/L to 150 g/L of one or more ions selected from the group consisting of sulfate ions, nitrate ions, chloride ions, and ions of oxyacids of chlorine or boron.

42. The aqueous trivalent chromium solution of claim 40, further containing 0.01 g/L to 150 g/L of one or more compounds of metal selected from the group consisting of alkali metals, alkaline earth metals, vanadium, manganese, nickel, tin, gold, silver, copper, aluminum, iron, and zirconium.

43. The aqueous trivalent chromium solution of claim 40, further containing 0.01 g/L to 150 g/L of fluorine compound.

44. The aqueous trivalent chromium solution of claim 40 further containing 0.01 g/L to 200 g/L of a silicon compound.

45. The aqueous trivalent chromium solution for the process of claim 25, comprising (i) 0.01-50 g/L of chromium, and (ii) 0.1-600 g/L of at least two selected from the group consisting of sulfate ions, nitrate ions, chlorine ions, and oxyacid ions of chlorine or boron, having a pH of 0.5-6, with 95% or more of said chromium being a trivalent chromium.

46. The aqueous trivalent chromium solution according to claim 45, containing at least two selected from the group consisting of sulfuric acid compounds, nitric acid compounds, chlorine compounds, oxyacid compounds of chlorine or boron, oxyacid compounds of phosphorus, and fluorine compounds.

47. The aqueous trivalent chromium solution according to claim 45, containing at least two compounds of metal selected from the group consisting of alkali metals, alkaline earth metals, vanadium, manganese, nickel, tin, gold, silver, copper, aluminum, iron, and zirconium.

48. The aqueous trivalent chromium solution according to claim 47, wherein at least one of the at least two compounds of metals selected from the group consisting of alkali metals, alkaline earth metals, aluminum, titanium, vanadium, cobalt, nickel, manganese, tin, gold, silver, copper, iron, and zirconium is a compound of a metal selected from the group consisting of aluminum, titanium, vanadium, cobalt and nickel.

49. The aqueous trivalent chromium solution according to claim 40, further containing 1 g/L to 80 g/L of a chelating agent.

50. The aqueous trivalent chromium solution according to claim 40, further containing 0.01 g/L to 200 g/L of a silicon compound.

51. The aqueous trivalent chromium solution of claim 40, further containing 0.01 g/L to 350 g/L of a sulfur compound.

52. The aqueous trivalent chromium solution of claim 40 further containing a dye.

53. A pretreatment liquid solution for use in the process according to claim 18, containing at least one of 0.01 g/L to 100 g/L of a surface active agent, 0.1 g/L to 600 g/L of a fluorine compound and 0.1 g/L to 600 g/L of an oxyacid of phosphorus.

54. A pretreatment liquid solution for treatment of aluminum element in the process according to claim 18, containing at least one of 0.01 g/L to 100 g/L of a surface active agent, 0.1 g/L to 600 g/L of a fluorine compound and 0.1 g/L to 600 g/L of an oxyacid of phosphorus.

55. The process of claim 25, wherein the detergent contains 0.001 g/L to 300 g/L of a surface active agent.

56. The process according to claim 55, wherein the detergent contains at least one selected from the group consisting of organic acids, the salts of the acids, amine compounds, fluorine compounds, and oxyacids of phosphorus.

57. The process according to claim, 26, wherein the activator contains 10 g/L to 850 g/L of an oxyacid of phosphorus and/or 0.1 g/L to 600 g/L of a fluorine compound.

58. The process according to claim 57, wherein the activator further contains 0.01 g/L to 100 g/L of a surface active agent.

59. The process according to claim 57, wherein the activator further contains at least one selected from the group of organic acids, salts of the acids, and amines.

60. A process according to claim 36, wherein the overcoat agent is at least one selected from olefin resins, acrylic resins, alkyd resins, urea resins, epoxy resins, melamine resins, fluororesins, polyethylenes, polyvinyl chlorides, polystyrenes, polypropylenes, methacrylic resins, phenol resins, polyester resins, polyurethanes, polyamides, polycarbonates, and silicate compounds.

61. The process according to claim 26, wherein the trivalent chromium solution contains at least two selected from the group consisting of sulfuric acid compounds, nitric acid compounds, chlorine compounds, oxyacids of chlorine or boron, and at least one of the at least two are selected from the oxyacids of phosphorus and fluorine compounds.

62. The process according to claim 26, wherein the trivalent chromium solution contains at least two compounds of metals selected from the group consisting of alkali metals, alkaline earth metals, aluminum, titanium, vanadium, cobalt, nickel, manganese, tin, gold, silver, copper, iron, and zirconium.

63. The process according to claim 62, wherein at least one of the at least two compounds of metals selected from the group consisting of alkali metals, alkaline earth metals, aluminum, titanium, vanadium, cobalt, nickel, manganese, tin, gold, silver, copper, iron, and zirconium is selected from compounds of metals selected from the group consisting of aluminum, titanium, vanadium, cobalt and nickel.

64. The process according to claim 17, comprising, after treating with the trivalent chromium solution, contacting the surface of the aluminum element with at least one selected from overcoat agents, surface active agents, coating materials, resins, dyes, and silicon compounds.

65. The process according to claim 25, comprising, after treating with the trivalent chromium solution, contacting the surface of the aluminum element with at least one selected from overcoat agents, surface active agents, coating materials, resins, dyes, and silicon compounds.

66. The process according to claim 26, comprising, after treating with the trivalent chromium solution, contacting the surface of the aluminum element with at least one selected from overcoat agents, surface active agents, coating materials, resins, dyes, and silicon compounds.
